(19) United States
(12) Patent Application Publication
(10) Pub. No.: US 2014/0009015 A1
(43) Pub. Date: Jan. 9, 2014

(54) ELECTRIC MACHINE HAVING A COOLING SYSTEM AND METHOD OF COOLING AN ELECTRIC MACHINE

(71) Applicants: Noman Hossain, Fort Wayne, IN (US); Timothy Sailors, Carmel, IN (US); Anthony Trzaska, Carmel, IN (US)

(72) Inventors: Noman Hossain, Fort Wayne, IN (US); Timothy Sailors, Carmel, IN (US); Anthony Trzaska, Carmel, IN (US)

(73) Assignee: REMY TECHNOLOGIES, L.L.C., Pendleton, IN (US)

(21) Appl. No.: 13/542,320

(22) Filed: Jul. 5, 2012

(51) Int. Cl. H02K 5/20

(52) U.S. Cl. 310/59

(57) ABSTRACT

An electric machine including a housing having a body including an inner surface that defines an interior, a first end defining an opening exposing the interior, and a second end. A stator is fixedly mounted to the inner surface of the housing. A rotor is supported within the interior. The rotor defines an axis of rotation. An end cover extends across the opening adjacent one of the first end and the second end of the stator. A cooling system is carried by the end cover. The cooling system includes a body having a cooling fluid plenum, a plurality of stator nozzles and a plurality of rotor nozzles. The stator nozzles are configured and disposed to direct multiple jets of a coolant toward the stator and the plurality of rotor nozzles are configured and disposed to guide multiple jets of the coolant toward the rotor.

### BACKGROUND OF THE INVENTION

Exemplary embodiments pertain to the art of electric machines and, more particularly, to an electric machine having a cooling system and method.

Electric machines produce work from electrical energy passing through a stator to induce an electro-motive force in a rotor. The electro-motive force creates a rotational force that causes the rotor to rotate or spin relative to the stator. The rotation of the rotor is used to power various external devices. Of course, electric machines can also be employed to produce electricity from an external work input. In either case, electric machines are currently producing greater torque output, are operated at higher speeds, and are being designed in smaller packages. The greater torque and higher speeds often result in harsh operating conditions such as high internal temperatures, vibration and the like on internal components of the electric machine. Accordingly, many conventional electric machines include coolant systems that are configured to lower internal temperatures to prolong an overall operational life of the internal components as well as improve electro-mechanical performance of the electric machine.

### BRIEF DESCRIPTION OF THE INVENTION

Disclosed is an electric machine including a housing having a body including an inner surface that defines an interior, a first end defining an opening exposing the interior, and a second end. A stator is fixedly mounted to the inner surface of the housing. The stator includes a first end and a second end. A rotor is supported within the interior. The rotor defines an axis of rotation. An end cover extends across the opening adjacent one of the first end and the second end of the stator. A cooling system is carried by the end cover. The cooling system includes a body having a cooling fluid plenum, a plurality of stator nozzles and a plurality of rotor nozzles. The stator nozzles are configured and disposed to direct multiple jets of a coolant toward the one of the first end and the second end of the stator and the plurality of rotor nozzles are configured and disposed to guide multiple jets of the coolant toward the rotor.

Also disclosed is a method of cooling an electric machine. The method includes delivering a cooling fluid into an end cover of the electric machine, passing the cooling fluid from the end cover into a cooling fluid plenum of a cooling system carried by the end cover, discharging a first portion of the cooling fluid through a plurality of stator nozzles toward a stator of the electric machine, and discharging another portion of the cooling fluid through a plurality of rotor nozzles toward a rotor of the electric machine.

### BRIEF DESCRIPTION OF THE DRAWINGS

The following descriptions should not be considered limiting in any way. With reference to the accompanying drawings, like elements are numbered alike:

FIG. 1 depicts a cross-sectional view of an electric machine having a cooling system in accordance with an exemplary embodiment;

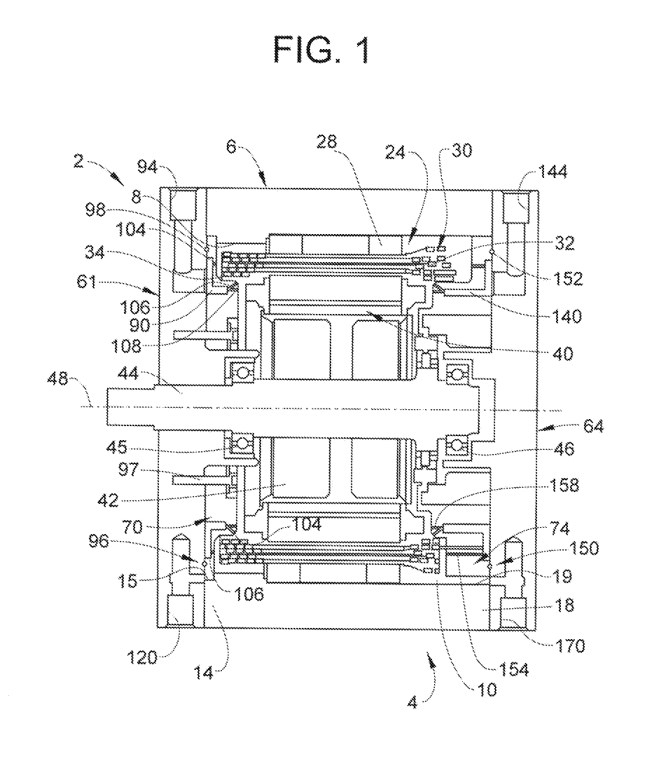

FIG. 2 depicts a perspective view of a first end cover of the electric machine of FIG. 1, including a cooling system in accordance with an aspect of the exemplary embodiment;

FIG. 3 depicts a partial cross-sectional detail view of a portion of the cooling system of FIG. 2

FIG. 4 depicts a perspective view of a second end cover of the electric machine of FIG. 1 including a cooling system in accordance with another aspect of the exemplary embodiment; and

FIG. 5 depicts a partial cross-sectional detail view of a portion of the cooling system of FIG. 4.

### DETAILED DESCRIPTION OF THE INVENTION

A detailed description of one or more embodiments of the disclosed apparatus and method are presented herein by way of exemplification and not limitation with reference to the Figures.

An electric machine in accordance with an exemplary embodiment is indicated generally at 2. Electric machine 2 includes a housing 4 having a body 6. Body 6 includes an inner surface 8 that defines an interior 10. Body 6 also includes a first end 14 that defines a first opening 15 and a second end 18 that defines a second opening 19. Electric machine 2 is shown to include a stator 24 mounted to inner surface 8. Stator 24 includes a stator core 28 provided with a plurality of stator windings 30. Windings 30 include a first or crown side 32 and a second or weld side 34. A rotor 40 is rotatably mounted within housing 4. Rotor includes a hub 42 mounted to a shaft 44. Shaft 44 is supported by bearings 45 and 46 and defines an axis of rotation 48 of rotor 40. Electric machine 2 is shown to include a first end cover 61 that extends across first opening 15 and a second end cover 64 that extends across second opening 19. First end cover 61 supports or carries a first cooling system 70 and second end cover 64 supports or carries a second cooling system 74.

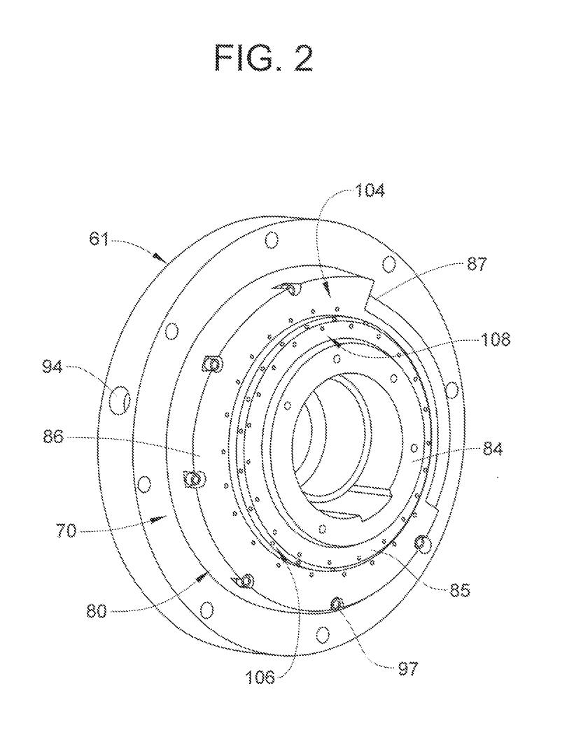

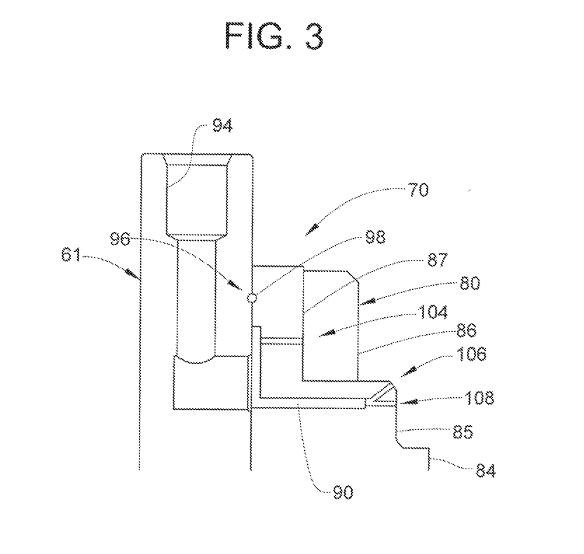

Reference will now be made to FIGS. 2-3 in describing first cooling system 70. First cooling system 70 includes a body 80 having a first step surface 84, a second step surface 85, a third step surface 86, and a fourth step surface 87. Body 80 also includes an internal cooling fluid plenum 90 that is fluidically connected to a cooling fluid inlet 94 provided on first end cover 61. Cooling system 70 is detachably mounted to first end cover 61 through a plurality of mechanical fasteners, one of which is shown at 97. The particular type of mechanical fastener used to join cooling system 70 to first end cover 61 may vary. A seal 96 is arranged between cooling system 70 and first end cover 61. Seal 96 is shown in the form of an O-ring 98 that prevents escape of cooling fluid from cooling system 70. Although depicted as an O-ring, seal 96 may take on a variety of forms.

Cooling system 70 is configured to guide a cooling fluid (liquid or gas) from cooling fluid plenum 90 onto portions of stator 24 and rotor 40. The particular type of cooling fluid employed in connection with cooling system 70 may vary. Cooling system 70 includes a first plurality of stator nozzles 104, a second plurality of stator nozzles 106, and a plurality of rotor nozzles 108. First plurality of stator nozzles 104 are arranged in an annular array on third step surface 86. In accordance with one aspect of the exemplary embodiment, a portion of first plurality of stator nozzles 104 may be provided on fourth step surface 87. Second plurality of stator nozzles 106 and the plurality of rotor nozzles 108 are arranged in a generally annular array about second step surface 85.

First plurality of stator nozzles 104 guide jets of liquid coolant along axis 48 onto crown end 32 of stator 24. Second plurality of stator nozzles 106 guide jets of cooling fluid at an angle relative to axis 48 toward an inner surface (not separately labeled) of crown side 32. The plurality of rotor nozzles 108 guide jets of cooling fluid along or substantially parallel to axis 48 toward rotor 40. The jets of cooling fluid flow over stator 24 and rotor 40 to lower operating temperatures of both components. The cooling fluid collects within interior 10 and passes from housing 4 through a cooling fluid outlet 120. The cooling fluid may be passed through a heat exchanger (not shown) prior to re-introduction to housing 4, or may simply pass to a cooling fluid collection vessel (also not shown).

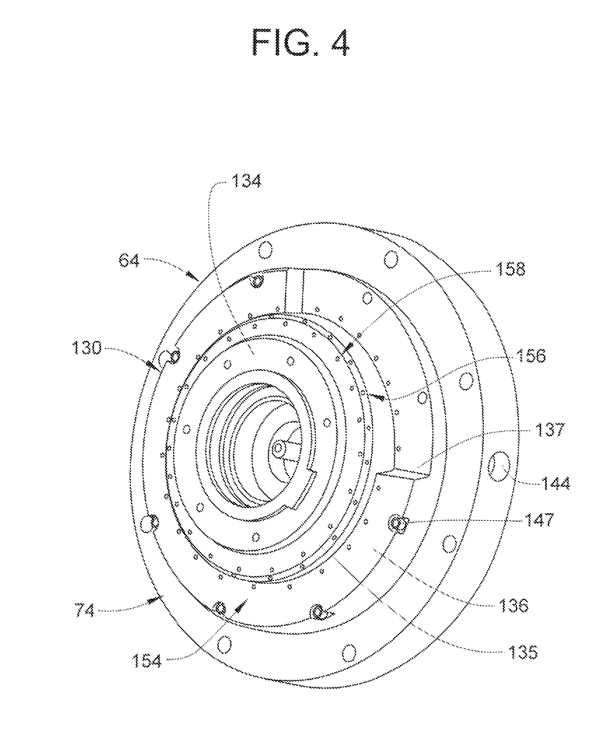

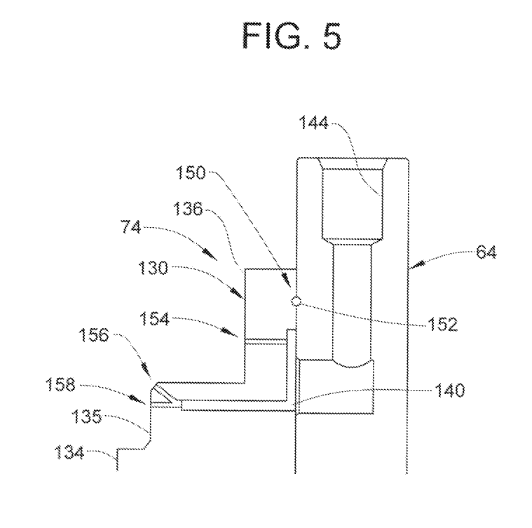

Reference will now be made to FIGS. 4-5 in describing second cooling system 74. Second cooling system 74 includes a body 130 having a first step surface 134, a second step surface 135, a third step surface 136, and a fourth step surface 137. Body 130 also includes an internal cooling fluid plenum 140 that is fluidically connected to a cooling fluid inlet 144 provided on second end cover 64. Cooling system 74 is detachably mounted to second end cover 64 through a plurality of mechanical fasteners, one of which is shown at 147. The particular type of mechanical fastener used to join cooling system 74 to second end cover 64 may vary. A seal 150 is arranged between cooling system 74 and second end cover 64. Seal 150 is shown in the form of an O-ring 152 that prevents escape of cooling fluid from cooling system 74. As discussed above, although depicted as an O-ring, seal 150 may take on a variety of forms.

Cooling system 74 is configured to guide a cooling fluid (liquid or gas) from internal cooling fluid plenum 140 onto portions of stator 24 and rotor 40. The particular type of cooling fluid employed in connection with cooling system 74 may vary. Cooling system 74 includes a first plurality of stator nozzles 154, a second plurality of stator nozzles 156, and a plurality of rotor nozzles 158. First plurality of stator nozzles 154 are arranged in a generally annular array on third step surface 136. In accordance with one aspect of the exemplary embodiment, a portion of the first plurality of stator nozzles 154 may be provided on fourth step surface 137. Second plurality of stator nozzles 156 and the plurality of rotor nozzles 158 are arranged in an annular array about second step surface 135.

First plurality of stator nozzles 154 guide jets of liquid coolant along axis 48 onto weld end 34 of stator 24. Second plurality of stator nozzles 156 guide jets of cooling fluid at an angle relative to axis 48 toward an inner surface (not separately labeled) of weld side 34. The plurality of rotor nozzles 158 guide jets of cooling fluid along or substantially parallel to axis 48 toward rotor 40. The jets of cooling fluid flow over stator 24 and rotor 40 to lower operating temperatures of both components. The cooling fluid collects within interior 10 and passes from housing 4 through a cooling fluid outlet 170. In a manner similar to that discussed above, the cooling fluid may be passed through a heat exchanger (not shown) prior to re-introduction to housing 4, or may simply pass to a cooling fluid collection vessel (also not shown). At this point it should be understood that cooling fluid outlet 120 and cooling fluid outlet 170 may lead to separate heat exchangers or may join and connect to a single heat exchanger.

At this point it should be understood that the exemplary embodiments provide a system for cooling internal components of an electric machine. The cooling systems in accordance with the exemplary embodiments include multiple nozzles that precisely deliver jets of cooling fluid onto components of the electric machine to reduce operating temperatures. The cooling systems are mounted to end covers of the electric machine and may be readily removed for service, repair or replacement. In addition, it should be understood that the electric machine need not be provided with both a plurality of stator nozzles that guide cooling fluid along an axis of the electric machine and a plurality of stator nozzles that guide cooling fluid at an angle to the axis. The particular degree of the angle may vary depending on the type and construction of the electric machine. Finally, it should be understood that the electric machine may only include a single cooling system positioned to guide cooling fluid onto one side or another of the stator. Also, it should be understood that the cooling system may include a single source or multiple sources of cooling fluid. Further, it should be understood that the cooling fluid may be a cooling liquid or, alternatively, a cooling gas.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. An electric machine comprising:
a housing having a body including an inner surface that defines an interior, a first end defining an opening exposing the interior, and a second end;
a stator fixedly mounted to the inner surface of the housing, the stator including a first end and a second end;
a rotor supported within the interior, the rotor defining an axis of rotation;
an end cover extending across the opening adjacent one of the first end and the second end of the stator; and
a cooling system carried by the end cover, the cooling system including a body having a cooling fluid plenum, a plurality of stator nozzles and a plurality of rotor nozzles, the stator nozzles being configured and disposed to direct multiple jets of a coolant toward the one of the first end and the second end of the stator and the plurality of rotor nozzles being configured and disposed to guide multiple jets of the coolant toward the rotor.

2. The electric machine according to claim 1, wherein the plurality of stator nozzles include a first plurality of stator nozzles configured and disposed to guide multiple jets of coolant toward the one of the first end and the second end of the stator along the axis defined by the rotor, and a second plurality of stator nozzles configured and disposed to guide multiple jets of coolant toward the one of the first end and the second end of the stator at an angle relative to the axis defined by the rotor.

3. The electric machine according to claim 2, wherein the first plurality of stator nozzles are arranged in a first generally annular array and the second plurality of stator nozzles are arranged in a second generally annular array.

4. The electric machine according to claim 3, wherein the first generally annular array is arranged radially inward of the second generally annular array.

5. The electric machine according to claim 3, wherein the plurality of rotor nozzles are configured and disposed to direct multiple jets of coolant toward the rotor along the axis defined by the rotor.

6. The electric machine according to claim 5, wherein the plurality of rotor nozzles are arranged in a third generally annular array.

7. The electric machine according to claim 6, wherein the third generally annular array is arranged radially inward of the first and second generally annular arrays.

8. The electric machine according to claim 1, further comprising: a cooling fluid inlet formed in the end cover and fluidically connected to the cooling fluid plenum.

9. The electric machine according to claim 1, further comprising: a cooling fluid outlet formed in the end cover and fluidically connected to the interior of the housing.

10. The electric machine according to claim 1, wherein the cooling system is detachably mounted to the end cover through one or more mechanical fasteners.

11. The electric machine according to claim 1, further comprising:
another opening defined at the second end of the housing;
another end cover extending across the another opening adjacent the other of the first end and the second end of the stator; and
another cooling system carried by the another end cover, the another cooling system including a body having a cooling fluid plenum, another plurality of stator nozzles and another plurality of rotor nozzles, the stator nozzles being configured and disposed to direct multiple jets of a coolant toward the other of the first end and the second end of the stator, and the plurality of rotor nozzles being configured and disposed to guide multiple jets of the coolant toward the rotor.

12. The electric machine according to claim 11, wherein the another plurality of stator nozzles include a third plurality of stator nozzles configured and disposed to guide multiple jets of coolant toward the other of the first end and the second end of the stator along the axis defined by the rotor, and a fourth plurality of stator nozzles configured and disposed to guide multiple jets of coolant toward the other of the one of the first end and the second end of the stator at an angle relative to the axis defined by the rotor.

13. The electric machine according to claim 11, wherein the another end cover includes a cooling fluid inlet fluidically coupled to the cooling fluid plenum and a cooling fluid outlet fluidically coupled to the interior of the housing.

14. The electric machine according to claim 11, wherein the another cooling system is detachably mounted to the another end cover through one or more mechanical fasteners.

15. A method of cooling an electric machine comprising:
delivering a cooling fluid into an end cover of the electric machine;
passing the cooling fluid from the end cover into a cooling fluid plenum of a cooling system carried by the end cover;
discharging a first portion of the cooling fluid through a plurality of stator nozzles toward a stator of the electric machine; and
discharging another portion of the cooling fluid through a plurality of rotor nozzles toward a rotor of the electric machine.

16. The method of claim 15, wherein discharging the first portion of the cooling fluid includes passing the first portion of the cooling fluid through a first plurality of stator nozzles along an axis defined by a rotor of the electric machine and through a second plurality of stator nozzles at an angle relative to the axis.

17. The method of claim 15, wherein discharging the another portion of the cooling fluid includes passing the cooling fluid through a plurality of nozzles along an axis defined by a rotor of the electric machine.

18. The method of claim 15, further comprising:
delivering additional cooling fluid to another end cover of the electric machine;
passing the additional cooling fluid from the another end cover into another cooling fluid plenum;
discharging a first portion of the additional cooling fluid through a plurality of stator nozzles toward a stator of the electric machine; and
discharging another portion of the additional cooling fluid through a plurality of rotor nozzles toward a rotor of the electric machine.

19. The method of claim 15, further comprising: collecting the cooling fluid at a cooling fluid outlet formed in the end cover.

20. The method of claim 19, further comprising: passing the cooling fluid from the electric machine through the cooling fluid outlet.
